(19) United States
(12) Patent Application Publication
(10) Pub. No.: US 2012/0000319 A1
(43) Pub. Date: Jan. 5, 2012

(54) Backup Tool for Holding Nuts

(75) Inventors: Peter Armstrong, Strongsville, OH (US); Kenneth C. Rickley, II, Houston, TX (US)

(73) Assignee: TITAN TECHNOLOGIES INTERNATIONAL, INC., Houston, TX (US)

(21) Appl. No.: 13/023,362

(22) Filed: Feb. 8, 2011

Related U.S. Application Data
(60) Provisional application No. 61/302,905, filed on Feb. 9, 2010.

(51) Int. Cl. B25B 23/10

(52) U.S. Cl. 81/13

(57) ABSTRACT

A backup tool supports a nut from rotation. The tool has a socket opening having opposing faces that lie along adjacent sides of an equilateral triangle. A threaded opening in the tool has an axis that intersects a third side of this equilateral triangle, and an adjustable screw threads into this opening. To adjustably fit the tool on a nut, the socket opening disposes around the nut, and the screw threads in the opening until the screw's distal end engages one of the six sides of a hex nut. The opposing faces along the sides of the equilateral triangle then engage two alternating sides of the hex nut. To support the nut from rotation, a reaction surface of the tool engages against a supporting surface of another nut, an edge of a flange, or the like.

### CROSS-REFERENCE TO RELATED APPLICATIONS

This is a non-provisional of U.S. Provisional Appl. Ser. No. 61/302,905, filed 9 Feb. 2010, which is incorporated herein by reference in its entirety and to which priority is claimed.

### BACKGROUND

In different industries, operators may use a backup tool to hold one nut in place on a bolt connecting the flanges while tightening or loosening another nut on the bolt. Such a backup tool fits on the nut and prevents it from rotating on the bolt when the other nut is being torqued or loosened.

As shown in FIG. 1A, a typical prior art backup tool 10 has a wrench 14 with an arm 12 extending therefrom. The wrench 14 defines a socket 16 for engaging a hex nut (not shown) when the tool 10 is disposed on the nut. On the arm 12, an inside surface 15 (commonly referred to as a reaction surface) fits against an adjacent nut (if present) or some other supporting element when the tool 10 fits on the nut to be held. A screw 18 passing through the arm 12 can be adjusted to alter the support provided by the reaction surface, depending on how the socket 16 fits on its nut and how the arm 12 extends relative to the adjacent nut or other support.

A similar backup tool 20 in FIG. 1B has a wrench 24 with an arm 22 extending therefrom, and the wrench 24 defines a socket 26 for engaging a nut (not shown). This arm 22 has a reaction lever 25 pivotably attached thereto for fitting against an adjacent nut (if present) or some other supporting element. Likewise, an adjustment screw 28 passing through the arm 22 can be adjusted to the position of the reaction lever 25 as needed.

Yet another backup tool 30 of the prior art shown in FIG. 1C has a toe 32 connected to a wrench 34 defining a socket 36. As before, the socket 36 fits on a hex nut. The toe 32 extends parallel to a bolt on which this nut is positioned so that the toe 32 fits against the edge of a flange 50 or other surface.

Although these backup tools of the prior art are effective, these tools may require operators to handle and support the tools more than desired during use. In addition, the tools do not have a consistent way to remain on the nut if it is upside down or even if the bolt shears free. Furthermore, a typical industrial setting may use nuts of all different sizes for the various flange and pipe connections. Working in such an environment, operators must keep numerous sizes of backup tools on hand.

The subject matter of the present disclosure is directed to overcoming, or at least reducing the effects of, one or more of the problems set forth above.

### SUMMARY

In one embodiment, a backup tool supports a nut (or other type of fastener or connector) from rotation. The tool has a wrench body and a support body. The wrench body defines a socket having first and second faces that oppose one another and that lie along adjacent sides of an equilateral triangle. Portion of the wrench body has a threaded opening with an axis that intersects a third side of this equilateral triangle. A screw threads into this opening and can be adjusted to engage a side of a nut disposed in the socket opening. In general, this nut can be a hex nut, but the tool can be used on square nuts and double-hex nuts as well as others. With the screw engaging one of the six sides of the hex nut, the opposing faces of the socket engage two alternating sides of the hex nut to hold it firmly.

To support the nut from rotation, a reaction surface of the tool engages against a supporting surface of another nut, an edge of a flange, or the like. For example, this reaction surface can be an arm that extends in the same plane from the wrench body, or it can be a toe that is perpendicular to the wrench body. In another alternative, a lever pivotably connected to the support body can have the reaction surface and can be adjusted as needed.

The foregoing summary is not intended to summarize each potential embodiment or every aspect of the present disclosure.

### BRIEF DESCRIPTION OF THE DRAWINGS

FIG. 1A is a side view of a first backup tool according to the prior art.

FIG. 1B is a perspective view of a second backup tool according to the prior art.

FIG. 1C is a perspective view of a third backup tool according to the prior art.

FIG. 2A is a side view of a backup tool according to the present disclosure.

FIG. 2B is a top view of the backup tool of FIG. 2A.

FIG. 3 is a plan view of two backup tools disposed on nuts on a flange.

FIG. 4A is a cross-section of the backup tool in a first arrangement for engaging a smaller nut.

FIG. 4B is a cross-section of the backup tool in a second arrangement for engaging a larger nut.

FIG. 5 shows the backup tool holding a nut and broken bolt and supported by a lanyard.

FIG. 6A is a side view of another backup tool according to the present disclosure having an open side for the socket.

FIG. 6B is a view of a bolt and nut arrangement used to hold flanges together when there is restricted access.

FIG. 7 is a side view of yet another backup tool according to the present disclosure having an adjustable lever.

FIG. 8 is a perspective view of yet another backup tool according to the present disclosure having a perpendicular toe.

FIG. 9 is a perspective view of a socket having an internal socket for engaging a nut.

FIG. 10A shows a backup tool for holding square nuts of various sizes.

FIG. 10B shows another backup tool for holding double-hex nuts of various sizes.

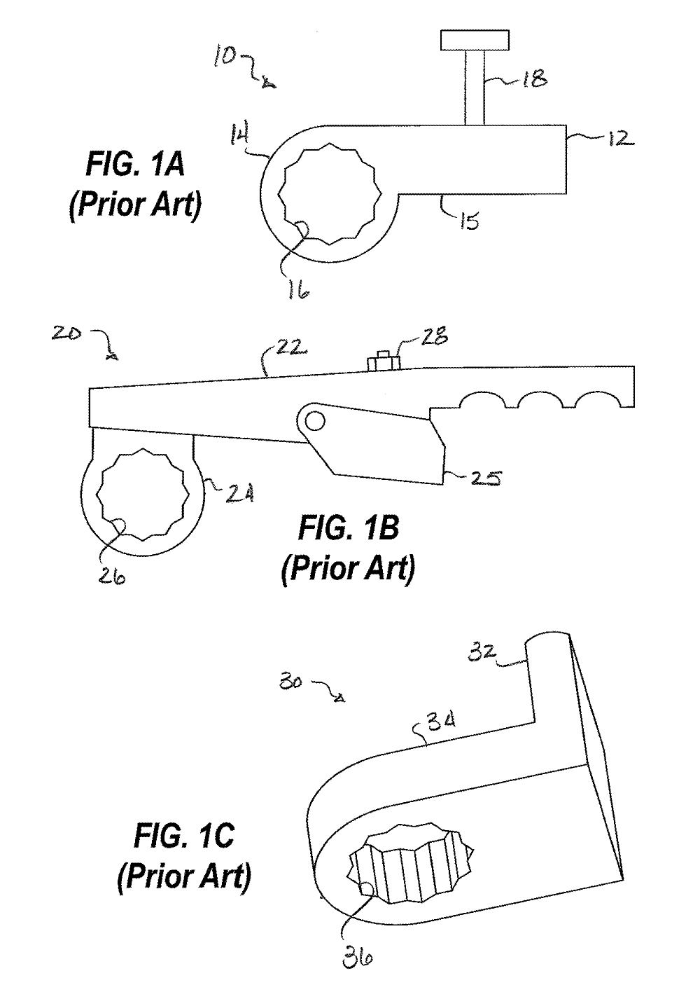

### DETAILED DESCRIPTION

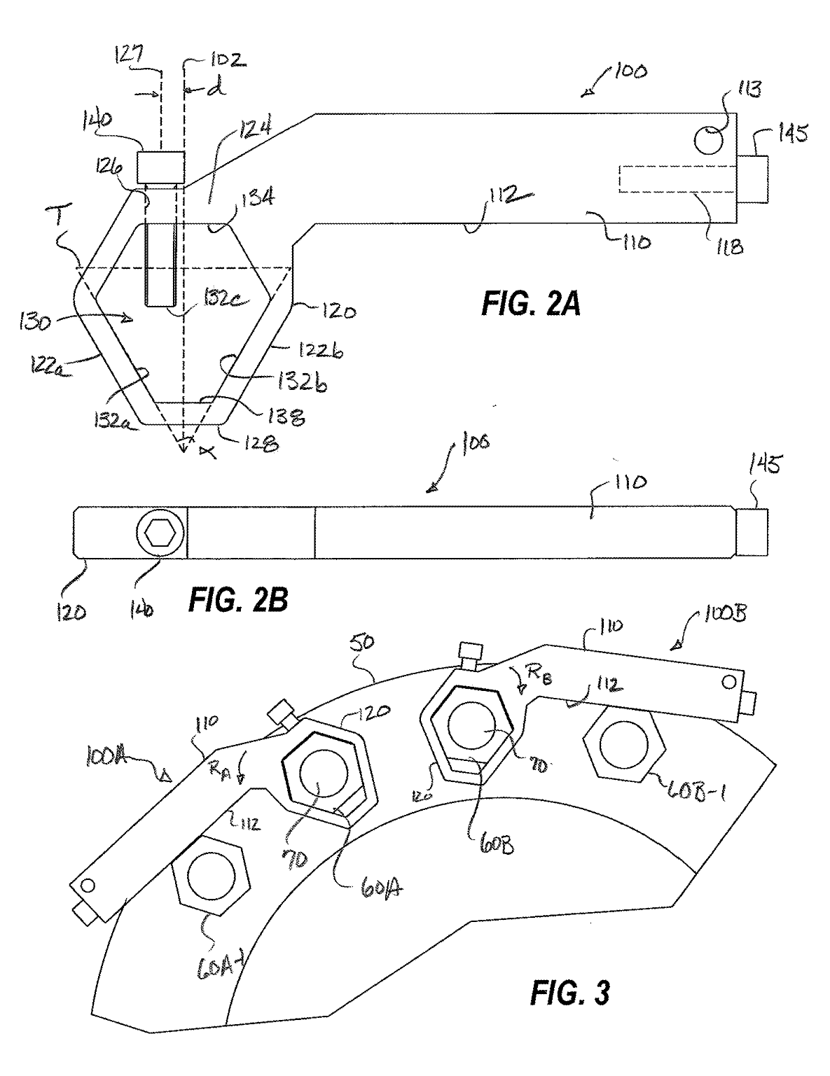

A backup tool 100 in FIGS. 2A-2B has a support body 110 and a wrench body 120. The wrench body 120 has a socket 130 for engaging nuts (or other type of fastener or connector) of various sizes so the backup tool 100 can hold the nut. As shown, the nut is a hex nut that threads on a bolt. The backup tool 100 can hold the nut when another nut on the bolt is tightened or loosened with a hydraulic torque wrench or the like. The support body 110, shown here as an arm, supports the wrench body 120 from rotation when the tool 100 is disposed on the hex nut.

The socket 130 is formed by various sides of the wrench body 120. In particular, first and second sides 122a-b of the wrench body 120 have inner faces 132a-b that define parts of the socket 130. As shown, these inner faces 132a-b oppose one another and lie along first and second adjacent sides of an equilateral triangle T (diagrammatically shown in FIG. 2A) separated by a shared angle a of 60-degrees. When a nut is disposed in the socket 130, these faces 132a-b entirely abut against the alternating sides of the hex nut regardless of size, as long as the nut is suited for the socket 130.

A third side 124 of the wrench body 120 is disposed opposite the shared angle a of the inner faces 122a-b. The inner face 134 of this third side 124 is preferably parallel to the third side of the equilateral triangle T. This inner face 134 may define a maximum length for a side of a hex nut useable in the socket opening 130.

As shown, a fourth side 128 of the wrench body 120 can connect the first and second sides 122a-b together. This fourth side 128 has a fourth inner face 138 that shares edges at 120-degree angles with the first and second inner faces 132a-b. This fourth inner face 138 defines a minimum length for a side of a hex nut useable in the socket opening 130.

As further shown, the third side 124 has a threaded opening 126 with an axis 127 intersecting (i.e., perpendicular) to the third side of the equilateral triangle T. An adjustment screw 140 adjustably threads in this threaded opening 126, and the screw's distal end disposes in the socket 130. The screw 140 can be adjusted relative to the inner faces 132a-b to adjust the size of hex nut that can be held in the wrench body's socket 130. Thus, the screw's distal end forms the socket's third inner face 132c so that the first, second, and third faces 132a-c can engage alternating sides of a hex nut as discussed below.

Another screw 145 having a different length can be held in another threaded opening 118 of the tool 100. As also discussed below, this other screw 145 can also be used in the threaded opening 126 of the wrench body 120 to allow the tool 100 to hold nuts of different sizes.

As shown in FIG. 2A, the axis of the screw 140 and threaded opening 126 preferably lies at an offset distance d from the centerline 102 of the equilateral triangle T. This offset distance d is opposite the support body 110 and allows the face 132c of the screw's distal end to engage near an edge of one of the hex nut's sides. In this position, the face 132c can act against the attempt of the hex nut to turn on a bolt toward the support body's reaction surface 112. In other implementations of the tool 100, the screw 140 and opening 126 can be disposed at the triangle's centerline or can be offset towards the support body 110.

The amount of this offset d from the centerline 102 is selected as a function of the intended sizes of nuts to be held in the socket 130. As an example, if the socket 130 is sized for nuts having NF sizes of about 1 in. to about 1.5 in., then the offset d may be about 5.27 mm (0.208 in.). Face 138 can have a length of about 16.04 mm. (0.632 in.), and face 134 can have a length about 22.14 mm (0.872 in.). The overall distance between faces 134/138 can be about 47.74 mm (1.958 in.). These dimensions are provided for illustrative purposes and can differ depending on the implementation and desired use of the tool.

As shown in FIG. 3, the backup tool 100 can disposed on nuts 60 on a flange 50 and can be arranged to prevent rotation in opposing directions. The orientation used for the tool 100 depends on the desired support and whether the opposing nut on the bolt is to be tightened or loosened. For example, the first backup tool 100A has its wrench body 120 disposed on a first nut 60A and has its reaction surface 112 engaging an adjacent nut 60A-1. When engaged in this way, the tool 100A prevents rotation of the nut 60A in a first direction R_{A} (shown here as counterclockwise and typically corresponding to loosening). Alternatively, the second backup tool 100B has its wrench body 120 disposed on a second nut 60B and has its reaction surface 112 engaging an adjacent nut 60B-1. When engaged in this way, the tool 100B prevents rotation of the nut 60B in a second direction R_{B} (shown here as clockwise and typically corresponding to tightening).

In use, an operator positions the socket 130 of the tool 100 on the nut 60 and tightens the adjustment screw 140. The nut 60 and tool 100 can then be rotated until the reaction surface 112 engages an adjacent nut, stopping rotation. Once engaged, the load is retained by the flat faces 132a-b and adjustment screw's face 132c of the tool 100. These faces 132a-c provide more surface area to engage the nut than the flats on a hex socket. With the nut 60 loosened, the other nut and bolt on the flange can be removed so the operator can removed the nut 60 held in the tool 100. Finally, the operator loosens the adjustment screw 140 to release the nut 60.

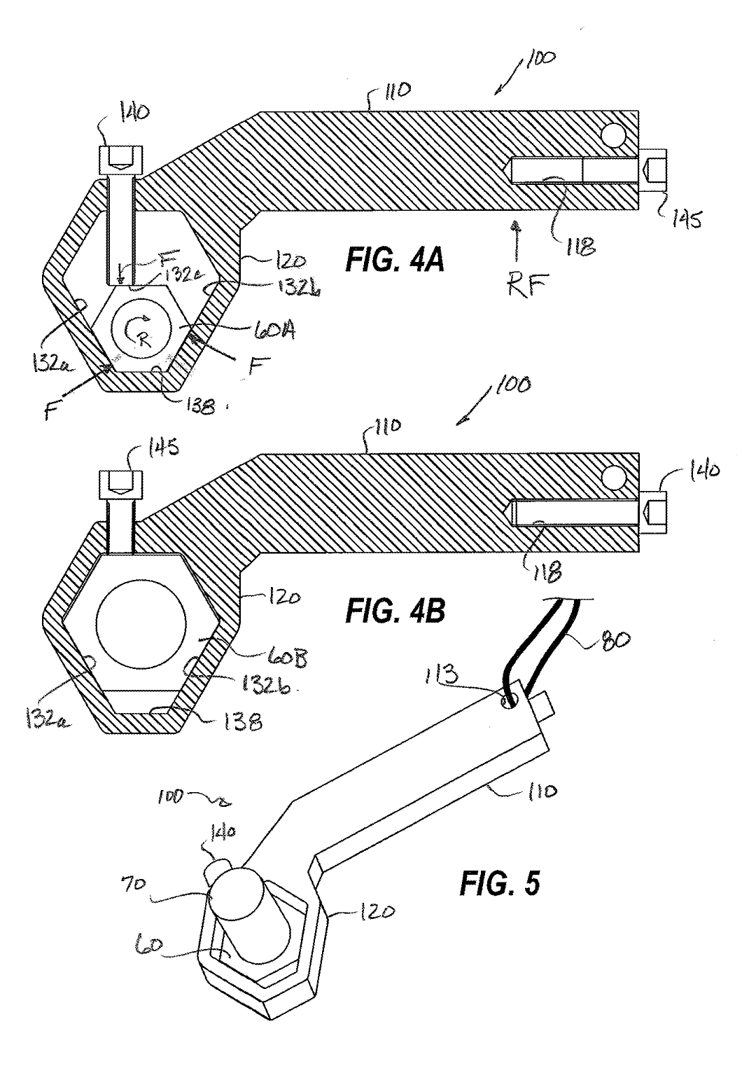

As noted previously, the backup tool 100 can be used on different sized hex nuts. In the cross-sectional view of FIG. 4A, the backup tool 100 is shown in a first arrangement engaging a smaller-sized hex nut 60A. The longer screw 140 is threaded in opening 126 so that its distal face 132c engages a side of the hex nut. Threading the screw 140 to engage the nut 60 can be done by hand, which may be sufficient for the tool 100 to provide its backup function. If additional tightening is needed, the screw 140 can be tightened using an Allen wrench or the like. The shorter adjustment screw 145 is shown stored in the threaded opening 118 of the support body 110.

As also shown in FIG. 4A, if the nut 60A has a tendency to turn in direction R and a reaction force acts against the support 110, the faces 132a-c of the tool 100 subject the alternating sides of the hex nut 60A with counterforces F to prevent its rotation. In particular, the screw 140 being offset subjects the nut's side adjacent its face 132c with a counterforce F toward the edge. The other faces 132a-b, although configured to abut the corresponding sides of the hex nut, also subject the nut's sides with counterforces F towards their edges.

FIG. 4B shows the backup tool 100 in a second arrangement for engaging a larger-sized nut 60B. Here, the shorter screw 145 threads into the opening 126 so that its distal face 132c engages a side of the hex nut. The longer adjustment screw 145 stores in the other threaded opening 118 of the support body 110. Being able to thread the adjustment screws 140/145 alternatingly in the openings 118/126 makes the tool 100 more versatile for operators to use in the field and keeps excess length of the screw from sticking beyond the wrench body 120.

As FIGS. 4A-4B show, the three faces 132a-c engage three alternate sides of the hex nut to prevent its rotation. Although the wrench body 120 has face 138 that may limit the smallest sized nut the socket 130 can hold, the sides 122a-b of the body 120 in an alternate arrangement could extend further, even meeting at their shared angle. This would allow the tool 100 to hold even smaller nuts as long as the screw 140 has sufficient length. Practical limitations, however, may make the other face 134 with the opening 126 define the maximum size of nut that the tool 100 can engage, even without using the smaller screw 145.

Not only does the screw 140 allow the tool 100 to hold different sized nuts, but also the threaded screw 140 helps to hold the tool 100 on the nut, allowing operators to use the tool 100 in a hands-free manner. Moreover, the tightened screw 140 has additional benefits should the bolt break or the nut somehow come off the bolt. For example, FIG. 5 shows the backup tool 100 holding a hex nut 60 and broken bolt 70 and supported by a lanyard 80. Because the adjustment screw 140 threads to engage the nut 60, the nut 60 remains held in the socket 130 even if the bolt 70 on which the nut 60 is threaded shears free. In this way, the bolt 70 and nut 60 will not fall freely away from a flange to cause damage elsewhere. Instead, the tool 100 holds these potentially loose items. In addition, the lanyard 50 attached in opening 113 of the tool 110 can keep the tool 100 from falling away as well.

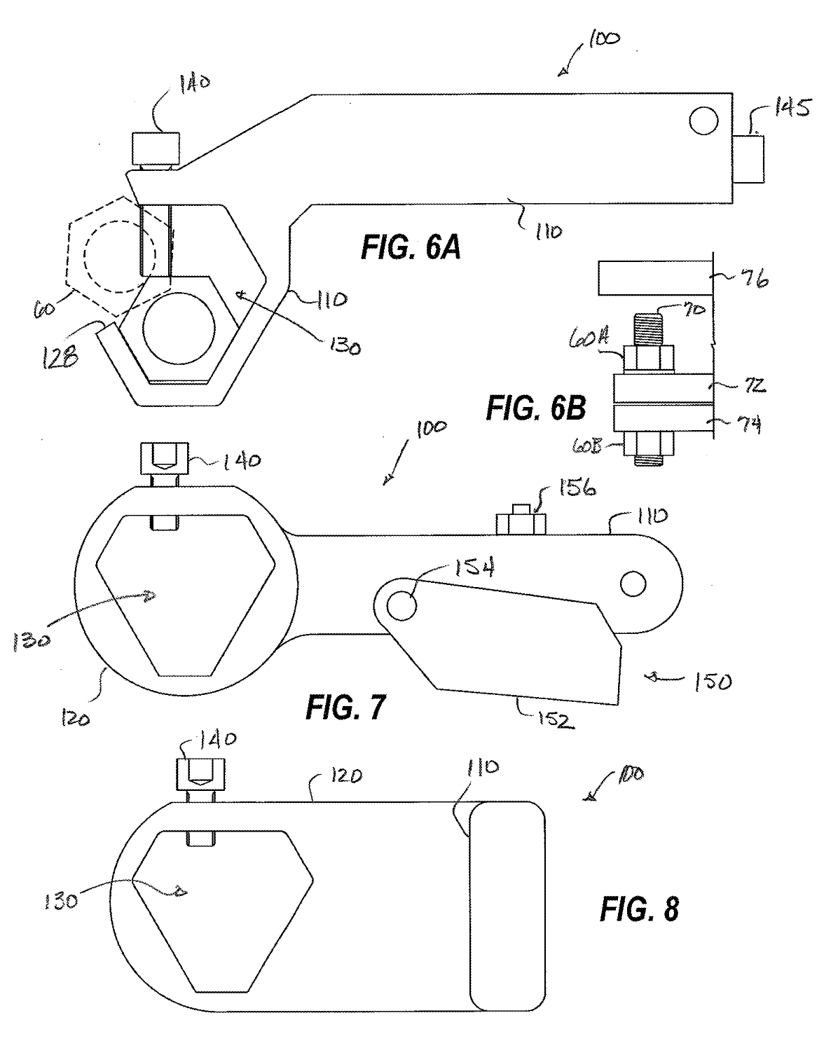

Sometimes access to a nut on a bolt may be limited. Accordingly, the backup tool 100 of the present disclosure can be modified to include an open side, slot, or gap, as shown in FIG. 6A. Much of the tool 100 is the same as discussed previously. However, one side 122a of the wrench body 120 defines a slot or gap 128 that allows nuts 60 (at least of certain sizes) to fit therethrough. This gap 128 may be useful when the tool 100 is used on a hard-to-access nut 60. For example, FIG. 6B shows two flanges 72/74 coupled together by a bolt 70 and nuts 60A-B. Access to one nut 60A is restricted by an obstruction 76 from another component, such as another flange, and may be restricted by an extending end of the bolt 70. Tightening or loosing the nuts 60A-B may require operators to use a hydraulic torque wrench. Due to access limitations, the torque wrench may have to be used on the second, accessible nut 60B for this purpose. Operators must then use the backup tool 100 on the restricted nut 60A. If the area is too restrictive, then operators can use the backup tool 100 having the gap 128 to fit on this nut 60 for locking.

As shown in FIG. 6A, the adjustment screw 140 can be removed, and the wrench body 120 can slip onto the nut, passing it through gap 128. Then, the screw 140 can be tightened on the nut. Of course, the size of the gap 128 on may limit the size of nut on which the tool 100 can be used. In any event, the side 122a should be able to support the nut's face at its edge, and the side 122a should be robust enough to withstand the required stresses. Although these limitations may limit the size that the gap 128 can have, the ability to fit the wrench body 120 on a nut with limited accessibility can be advantageous in some implementations.

Although the support body 110 in FIG. 2A is an arm extending from the wrench body 120, the support body 110 can have other possible configurations to prevent the wrench body 120 from rotating. For example, FIG. 7 shows a support body 110 that is also an arm. However, this support body 110 has a lever 150 pivotably connected to the support body 110 at a pivot point 154. Rather than the support body 120 having the reaction surface, the lever 152 provides an adjustable reaction surface for supporting the tool 100 from rotation. An adjustment screw 156 passes through the support body 110 and can adjust the pivot of the lever 152. This allows the wrench body 120 and socket 130 to fit onto a hex nut (not shown) regardless of its orientation, while the lever 152 can be adjusted to rest against a surface of another nut, flange, or the like for support.

In another alternative shown in FIG. 8, the support body 110 of the backup tool 100 can be a toe 110 that extends perpendicular to the plane of the wrench body 120. When the tool 100 disposed with a hex nut in the socket opening 130, the toe 110 can engage an edge of a flange or the like and can prevent rotation of the tool 100. The socket opening 130 can be situated as shown with the adjustment screw 140 disposed in a side of the tool 100. Alternatively, the screw's threaded opening 126 can be situated differently with the adjustment screw 140 extending from an end of the tool 100 or other direction.

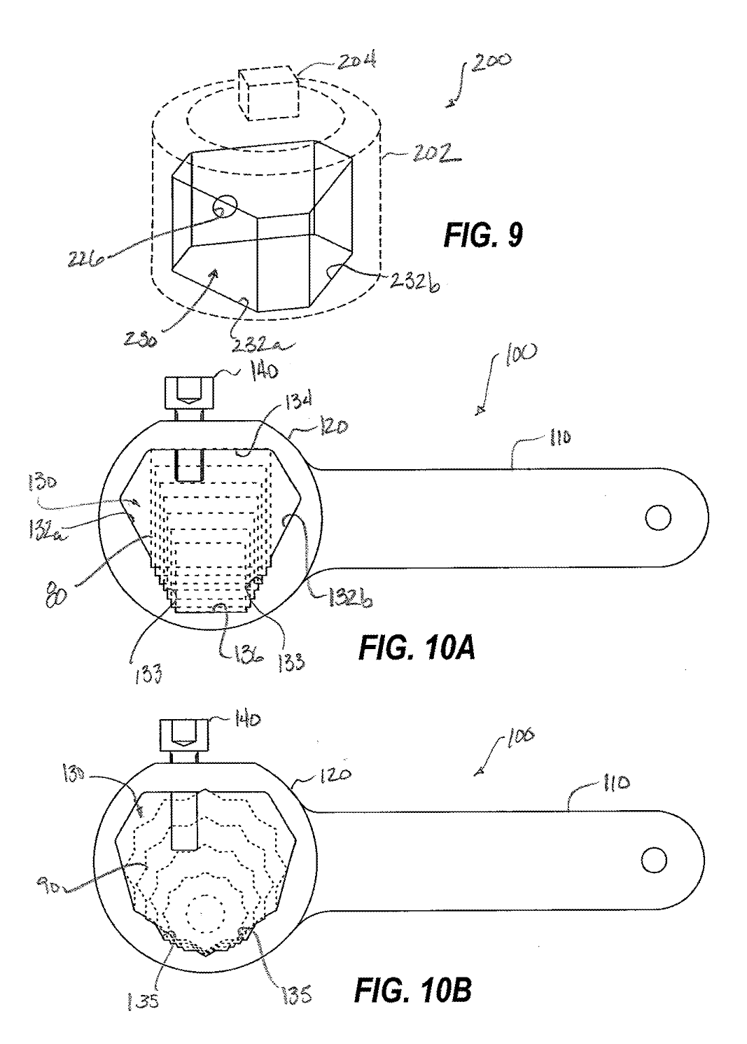

Although the tool 100 as disclosed herein has been described as being a backup tool to prevent rotation of a nut when another nut on a bolt is being tightened or loosened, the tool 100 can be used as a wrench for directly tightening or loosing of nuts on a bolt. Also, as shown in FIG. 9, the teachings of the present disclosure can be applied to a socket 200 having an internal socket 230 defined in a body 202 for engaging a nut (not shown) therein. The socket body 202 also has a square socket member 204 on top for engagement by a wrench. The internal socket 230 has the two opposing faces 232a-b on the equilateral triangle as before, and the socket 200 defines a threaded opening 226 that can receive an adjustment screw (not shown) to provide the third face for engaging the nut in the internal socket 230.

As hinted at previously, the tool of the present disclosure can be used on nuts or other types of fasteners or connectors. Hex nuts have been shown previously. In FIG. 10A, a backup tool 100 can be used for holding square nuts 80 of various sizes. Many aspects of the tool 100 are the same as described previously. The opposing faces 132a-b, however, define squared steps 133. When a square nut 80 is disposed in the socket 130, corners of the nut 80 can fit in these steps 133, which are preferably sized for particular nuts 80. The adjustment screw 140 can then thread in the wrench body 120 to engage a side of the square nut 80.

The intermediate side 136 between the opposing faces 132a-b may define the smallest sized face for square nut 80 that can be used in the socket 130. Likewise, the opposing side 134 may define the largest sized face for square nut 80 that can be used in the socket 130. Because the faces 132a-b may still adequately engage sides of a hex nut, the tool 100 of FIG. 10A may also be used with hex nuts as before in addition to being useable with the square nut 80 as shown.

In FIG. 10B, a backup tool 100 can be used for holding double-hex nuts 90 of various sizes. Many aspects of the tool 100 are the same as described previously. The opposing faces 132a-b, however, defines angled steps 133. When a double-hex nut 90 is disposed in the socket 130, corners of the nut 80 can fit in these steps 133, which are preferably sized for particular nuts 80. The adjustment screw 140 can then thread in the wrench body 120 to engage a side of the double-hex nut 90. The intermediate side 136 between the opposing faces 132a-b may define the smallest sized face for square nut 80 that can be used in the socket 130. Likewise, the opposing side 134 may define the largest sized face for square nut 80 that can be used in the socket 130.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A backup tool, comprising:
a body having a socket defined by first and second faces, the first and second faces opposing one another and disposed along first and second adjacent sides of an equilateral triangle;
a portion of the body disposed opposite a shared angle of the first and second faces and having a first opening, the first opening defining an axis intersecting a third side of the equilateral triangle; and
a first adjustment screw adjustably threading in the first opening and defining a third face disposing in the socket, wherein the first, second, and third faces engage sides of a fastener disposed in the socket.

2. The tool of claim 1, wherein the body comprises a support disposed thereon for supporting the body from rotation.

3. The tool of claim 2, wherein the support comprises an arm extending in a same plane as defined by the body.

4. The tool of claim 2, wherein the support comprises a toe extending perpendicular to a plane defined by the body.

5. The tool of claim 2, wherein the support comprises:
a lever pivotably connected to the body at a pivot point; and
a second adjustment screw passing through the body and adjusting the pivot of the lever relative to the pivot point.

6. The tool of claim 1, wherein the body defines a second opening, and wherein the tool comprises a second adjustment screw having a different length than the first adjustment screw, the first and second adjustment screws being alternatingly threadable in the first and second openings.

7. The tool of claim 1, wherein the body defines a gap in the first face communicating with the socket.

8. The tool of claim 1, wherein the axis of the second opening is disposed at an offset distance from a centerline of the equilateral triangle.

9. The tool of claim 1, wherein the first and second faces entirely abut sides of the hex nut disposed in the socket.

10. The tool of claim 1, wherein the body is a socket.

11. The tool of claim 1, wherein the first and second faces defined steps for engaging corners of a square nut or a double-hex nut.

12. The tool of claim 1, wherein the fastener is a hex nut, and wherein the first, second, and third faces engage alternating sides of the hex nut disposed in the socket

13. The tool of claim 1, wherein the fastener is a square nut, and wherein the first and second faces define a plurality of squared steps for engaging corners of the square nut.

14. A backup tool, comprising:
a wrench body at least having first, second, and third portions defining a socket, the first and second portions having first and second faces opposing one another and disposed along first and second adjacent sides of an equilateral triangle, the third portion disposed opposite a shared angle of the first and second faces, the third portion having a first opening defining an axis intersecting a third side of the equilateral triangle;
a support body disposed on the wrench body and supporting the wrench body from rotation; and
a first adjustment screw adjustably threading in the first opening and defining a third face disposing in the socket, wherein the first, second, and third faces engage alternating sides of a hex nut disposed in the socket.

15. The tool of claim 14, wherein the support body comprises an arm extending in a same plane as defined by the wrench body.

16. The tool of claim 14, wherein the support body comprises a toe extending perpendicular to a plane defined by the body.

17. The tool of claim 14, wherein the support body comprises:
a lever pivotably connected to the support body at a pivot point; and
a second adjustment screw passing through the support body and adjusting the pivot of the lever relative to the pivot point.

18. The tool of claim 14, wherein the support body defines a second opening, and wherein the tool comprises a second adjustment screw having a different length than the first adjustment screw, the first and second adjustment screws being alternatingly threadable in the first and second openings.

19. The tool of claim 14, wherein the first portion of the wrench body defines a gap communicating with the socket.

20. The tool of claim 14, wherein the axis of the second opening is disposed at an offset distance from a centerline of the equilateral triangle.

21. The tool of claim 14, wherein a fourth portion of the wrench body connects the first and second portions together, the fourth portion being opposite to the third portion and having a fourth face, the fourth face sharing edges with the first and second faces.

22. The tool of claim 14, wherein the first and second faces entirely abut sides of the hex nut disposed in the socket.

23. A nut backup method, comprising:
disposing a socket of a backup tool on a hex nut threaded on a bolt;
engaging three alternating sides of the hex nut by—
engaging a first side with a distal end of an adjustable screw on the backup tool, and
engaging second and third sides of the hex nut with opposing faces of the socket; and
supporting the backup tool from rotation by engaging a reaction surface of the backup tool against a supporting surface.

24. The method of claim 23, further comprising tightening or loosening another nut threaded on the bolt.

25. The method of claim 23, wherein engaging the reaction surface comprises supporting the reaction surface against a side of another nut.

26. The method of claim 23, wherein engaging the reaction surface comprises supporting the reaction surface against an edge of a flange through which the bolt passes.

27. The method of claim 23, wherein engaging the reaction surface comprises adjusting a lever having the reaction surface about a pivot point on the backup tool.

28. The method of claim 23, wherein engaging the screw comprises tightening the screw on the backup tool.

29. The method of claim 23, wherein the opposing faces of the socket are disposed along first and second adjacent sides of an equilateral triangle, and wherein the screw is disposed in the tool opposite a shared angle of the opposing faces and defines an axis intersecting a third side of the equilateral triangle.

30. The method of claim 23, wherein the axis of the screw is disposed at an offset distance from a centerline of the equilateral triangle.

31. The method of claim 23, further comprising storing another screw on the tool, the other screw having a different length.

32. The method of claim 23, wherein disposing the socket of the tool on the hex nut comprises slipping the hex nut through a gap defined in a side of the socket.
